(19) United States
(12) Patent Application Publication
(10) Pub. No.: US 2007/0172132 A1
(43) Pub. Date: Jul. 26, 2007

(54) PICTOGRAPHIC RECOGNITION TECHNOLOGY APPLIED TO DISTINCTIVE CHARACTERISTICS OF HANDWRITTEN ARABIC TEXT

(75) Inventor: Mark A. Walch, Woodbridge, VA (US)

Correspondence Address: BAKER & MCKENZIE LLP;PATENT DEPARTMENT, 2001 ROSS AVENUE, SUITE 2300, DALLAS, TX, 75201, US

(73) Assignee: THE GANNON TECHNOLOGIES GROUP, Alexandria, VA (US)

(21) Appl. No.: 11/621,000

(22) Filed: Jan. 8, 2007

Related U.S. Application Data
(60) Provisional application No. 60/758,092, filed on Jan. 11, 2006.

(51) Int. Cl. G06K 9/72; G06K 9/00

(52) U.S. Cl. 382/229; 382/187

(57) ABSTRACT

A method for recognizing handwritten Arabic character strings is disclosed. The handwritten Arabic character string is extracted. The handwritten Arabic character string is converted into a representative character string graph. Common embedded isomorphic graphs of the representative character string graph are extracted. A character string match is identified from each of the respective common embedded isomorphic graphs extracted using a data structure associated with each of the respective common embedded isomorphic graphs and a set of geometric measurements unique to the handwritten Arabic character string.

### APPLICATIONS FOR CLAIM OF PRIORITY

This application claims the benefit of U.S. Provisional Application No. 60/758,092 filed Jan. 11, 2006. The disclosure of the above-identified application is incorporated herein by reference as if set forth in full.

### CROSS REFERENCE TO RELATED APPLICATIONS

This application is related to U.S. patent application Ser. No. 10/791,375, entitled “SYSTEMS AND METHODS FOR SOURCE LANGUAGE WORD PATTERN MATCHING,” filed Mar. 1, 2004, U.S. patent application Ser. No. 10/936,451, entitled “SYSTEM AND METHOD FOR BIOMETRIC IDENTIFICATION USING HANDWRITING RECOGNITION,” filed Sep. 7, 2004, U.S. patent application Ser. No. 10/896,642, entitled “SYSTEMS AND METHODS FOR ASSESSING DISORDERS AFFECTING FINE MOTOR SKILLS USING HANDWRITING RECOGNITION,” filed Jul. 21, 2004, U.S. Provisional Application No. 60/758,009, entitled “TEST OF XP HANDWRITING CAPABILITY,” filed Jan. 11, 2006, U.S. Provisional Application No. 60/758,019, entitled “PROGRAM MANAGED DESIGN,” filed Jan. 11, 2006, and U.S. Provisional Application No. 60/758,008, entitled “CTG AUTOGROUPER CODING ENHANCEMENT TOOL,” filed Jan. 11, 2006. The disclosure of the above identified applications are incorporated herein by reference as if set forth in full.

### BACKGROUND

I. Field of the Invention

The embodiments disclosed in this application generally relate to Pictographic Recognition technologies used for recognizing and converting handwritten and machine printed text.

2. Background of the Invention

Pictographic Recognition (PR) technology is a term used herein to describe a Graph-Theory based method for locating specific words or groups of words within handwritten and machine printed document collections. This technique converts written and printed text forms into mathematical graphs and draws upon certain features of the graphs (e.g., topology, geometric features, etc.) to locate graphs of interest based upon specified search terms or to convert the graphs into text.

PR has been successfully used in the past as a search and recognition tool by identifying individual characters in strings of cursive handwritten English and Arabic script. However, the free flowing structure of handwritten text, especially Arabic, has posed some unique challenges for PR-based methodologies. First, Arabic is written in a cursive form so there is no clear separation between characters within words. Often, writers take considerable license in writing Arabic strings so that characters are either skipped or highly stylized. This makes it difficult to parse the string automatically into separate characters and to identify the individual characters within an Arabic word using computer-based recognition methodologies. Second, Arabic characters change their form depending on their word position (e.g., initial, middle, final, standalone, etc.). Third, Arabic words incorporate external characteristics such as diacritical markings. Lastly, Arabic writers often add a second “dimension” to writing by stacking characters on top of each other and the Arabic language is heavily reliant on ligatures (i.e., multiple characters combined into a single form) All these characteristics contribute to considerable dissimilarities between handwritten and machine printed forms of Arabic.

Analyzing Arabic text as individual multi-character clusters (i.e. “parts of Arabic words” or “PAWs”) addresses many of the above mentioned challenges. PAWs occur because of natural breaks in Arabic words caused by certain characters which do not connect with characters that follow them. In other words, PAWs are the byproduct of natural intra-word segmentation that is an intrinsic property of Arabic. PAWs create an opportunity for PR-based methodologies to focus on these “self-segmented” character strings within Arabic words and it is possible to treat the individual PAWs as if they were individual characters for recognition purposes. Therefore, PR-based methods are well suited to treat groups of characters as “word segments” and thus greatly enhance the task of locating and identifying full words within complex handwritten text (e.g., Arabic, etc.) that is cursive (connected), highly stylized and heavily reliant on ligatures.

### SUMMARY

Methods and apparatuses for using Pictographic Recognition technologies to search and to recognize complex handwritten language texts are disclosed.

In one aspect, a method for creating a modeling structure for classifying Arabic character strings is disclosed. A representative set of Arabic character strings is scanned. A character string is extracted from the representative set of Arabic words. The character string is labeled. The character string is converted into a representative character string graph. Common embedded isomorphic graphs of the representative character string graph are extracted. A plurality of character string identities sharing the same underlying graph topologies for each common embedded isomorphic graph extracted is ascertained. A data structure is created for each of the common embedded isomorphic graphs extracted. The data structure includes the plurality of character string identities ascertained. Each of the character string identities is associated with a set of geometric measurements unique to the character string identity.

In a different aspect, a method for recognizing handwritten Arabic character strings is disclosed. The handwritten Arabic character string is extracted. The handwritten Arabic character string is converted into a representative character string graph. Common embedded isomorphic graphs of the representative character string graph are extracted. A character string match is identified from each of the respective common embedded isomorphic graphs extracted using a data structure associated with each of the respective common embedded isomorphic graphs and a set of geometric measurements unique to the handwritten Arabic character string.

In a separate aspect, a computing device for operating an Arabic language recognition process for handwritten Arabic character strings is disclosed. The handwritten Arabic character string is extracted. The handwritten Arabic character string is converted into a representative character string graph. Common embedded isomorphic graphs of the representative character string graph are extracted. A character string match is identified from each of the respective common embedded isomorphic graphs extracted using a data structure associated with each of the respective common embedded isomorphic graphs and a set of geometric measurements unique to the handwritten Arabic character string.

In another aspect, a method for recognizing handwritten character strings is disclosed. The handwritten character string is extracted. The handwritten character string is converted into a representative character string graph. Common embedded isomorphic graphs of the representative character string graph are extracted. A character string match is identified from each of the respective common embedded isomorphic graphs extracted using a data structure associated with each of the respective common embedded isomorphic graphs and a set of geometric measurements unique to the handwritten character string.

These and other features, aspects, and embodiments of the invention are described below in the section entitled “Detailed Description.”

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 is an illustration of the handwritten and graph forms of the word “Center”, in accordance with one embodiment.

FIG. 2 is an illustration of two isomorphic graphs with different features, in accordance with one embodiment.

FIG. 3A is an illustration of sample character “a” for three different graph isomorphic classes, in accordance with one embodiment.

FIG. 3B is an illustration of sample characters “a” and “e” sharing the same isomorphic graph, in accordance with one embodiment.

FIG. 4A is an illustration comparing an original handwritten form of an Arabic word segment to the common embedded forms of the word segment, in accordance with one embodiment.

FIG. 4B is an illustration of two representations of the character “E” where one representation is the common embedded form of the other, in accordance with one embodiment.

FIG. 5A is an illustration of the various types of measurements that can be obtained from a character or word segment graph, in accordance with one embodiment.

FIG. 5B is an illustration of how the distances among the various graph features may be measured, in accordance with one embodiment.

FIG. 5C is an illustration of how the angle may be measured may be measured in two separate classes of graph components, in accordance with one embodiment.

FIG. 5D is an illustration of the various other forms of descriptor features on the graph that may also be measured, in accordance with one embodiment.

FIG. 6 is a depiction of how the isomorphic graphs of an Arabic word segment and an English character may be aligned for feature vector comparison purposes, in accordance with one embodiment.

FIG. 7 is a tree diagram illustrating the process flow for how the feature vectors may be used to distinguish the graph from one particular character, word segment, or word from all the other characters, segments or words having the same isometric graph, in accordance with one embodiment.

FIG. 8 is a flowchart of a method for creating a modeling structure for the various common embedded isomorphic graphs used in classifying handwritten words, word segments or characters, in accordance with one embodiment.

FIG. 9 is a flowchart depicting a method for identifying handwritten character strings, in accordance with one embodiment.

FIG. 10 is a depiction of the results of a classification of an unknown handwritten character string utilizing the data structures of the common embedded isomorphic graphs extracted for the handwritten character string, in accordance with one embodiment.

FIG. 11 is an illustration of how the results from a classification of an unidentified handwritten character string using a data structure may be presented, in accordance with one embodiment.

### DETAILED DESCRIPTION

Methods and apparatuses for using Pictographic Recognition technologies to search and to recognize complex handwritten language text are disclosed. Although all references herein are made to “handwritten” language, the methods and apparatuses described are equally applicable to “machine generated” text (i.e. font-based text from a laser printer). The handwriting example is cited because it represents the harder recognition problem. It will be obvious, however, that the present invention may be practiced without some or all of these specific details. In other instances, well known process operations have not been described in detail in order not to unnecessarily obscure the present invention.

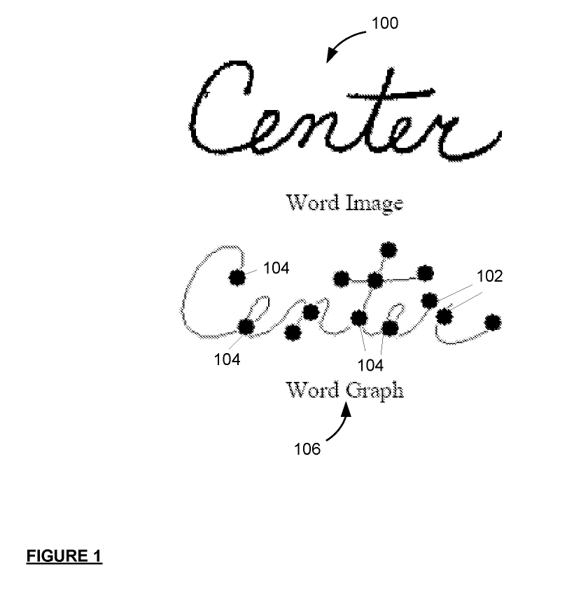

As used herein, Graph Theory is a branch of mathematics that focuses on representing relationships as line diagrams containing nodal points and linkages among these points. As shown in FIG. 1, a graph 106 is comprised of multiple nodal points 102 and linkages 104. Nodal points 102 (also known as vertices) are points at which strokes cross and linkages 104 (also known as edges) are the actual strokes that comprise the word 100. In all written language, graphs offer direct means of capturing the essence of the written form. The graph 106 coverts all the information extracted from the word 100 into a concise mathematical format that is highly computable. In one embodiment, the word 100 is an Arabic word. In another embodiment, the word 100 is an English word. It should be appreciated that the word 100 may be in any language as long as the words 100 written in the language may be processed using Graph Theory into a graphic form that captures nodal point 102, linkage 104 and vector feature information unique to the word 100. The extensibility of the methods herein described to all written language results from the common origin of writing systems as shapes inscribed as line forms.

Within the graph 106, the connectivity among the nodal points 102 and linkages 104 comprises the overall topology (i.e., structure) of the graph 106. Also captured within the graph 106 is the graph geometry, which is expressed in terms of distances, angles and other characteristics of the graph components (edges and vertices). The graph geometry can be expressed as a series of feature vectors (all features) or the graph's Alphabetic Kernel (selected features). The feature vector is a multi-dimensional expression of the multitude of measurements that are extracted from the graph 106 and the Alphabetic Kernel represents the subset of these features that distinguishes among isomorphic graphs representing different classes such as the letters of the alphabet. In one embodiment, the graph 106 in FIG. 1 depicts an entire word. In another embodiment, the graph in FIG. 1 depicts a word segment (a grouping of continuous characters within a word). In still another embodiment, the word graph 106 in FIG. 1 depicts just a single character. For purposes of simplifying the present discussion, the term “character string” will be used to represent words, parts of words, and individual characters that can be extracted from handwritten samples.

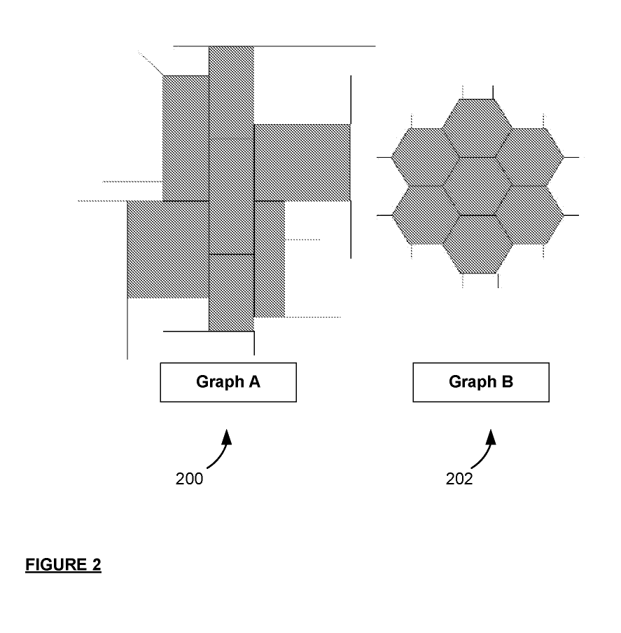

Two or more graphs are considered isomorphic when they have the same topologies. For example, as depicted in FIG. 2, Graph A 200 appears to have substantially different features than Graph B 202. However, Graph A 200 and Graph B 202 are considered isomorphic as they share an identical topology. That is, they (i.e., Graph A 200 and Graph B 202) have the same number of nodal points and strokes connected in exactly the same way. Graph A 200 and Graph B 202 appear to be different only because their respective geometries are different, that is, the topologies of Graph A 200 and Graph B 202 are identical whereas the angles and distances between their respective features (i.e., nodal points and linkages) are different. In one embodiment, the graph topologies are algorithmically converted to a representative numeric code (i.e., isomorphic database key). The unique code will always be associated with a particular unique topology and all topologies isomorphic to it. In another embodiment, the topologies, considered in concert with their attendant physical measurements, are converted into a representative word, character string or individual character. It should be understood, however, that the graph topologies may be converted into any type of data string as long as the string reproducibly conveys the topology and geometry of the character string in a format that can be readily computed. One method for constructing this code is presented in U.S. patent application Ser. No. 10/791,375, entitled “SYSTEMS AND METHODS FOR SOURCE LANGUAGE WORD PATTERN” herein incorporated by reference.

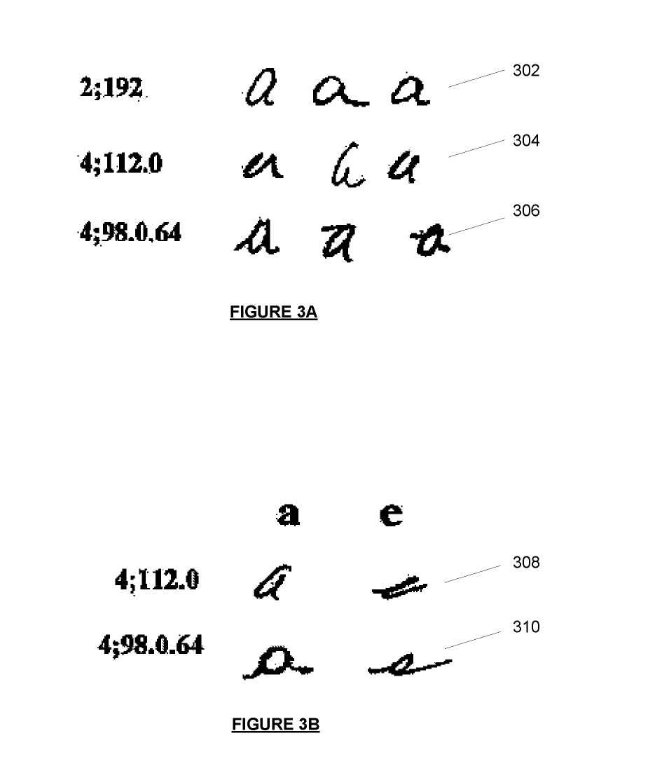

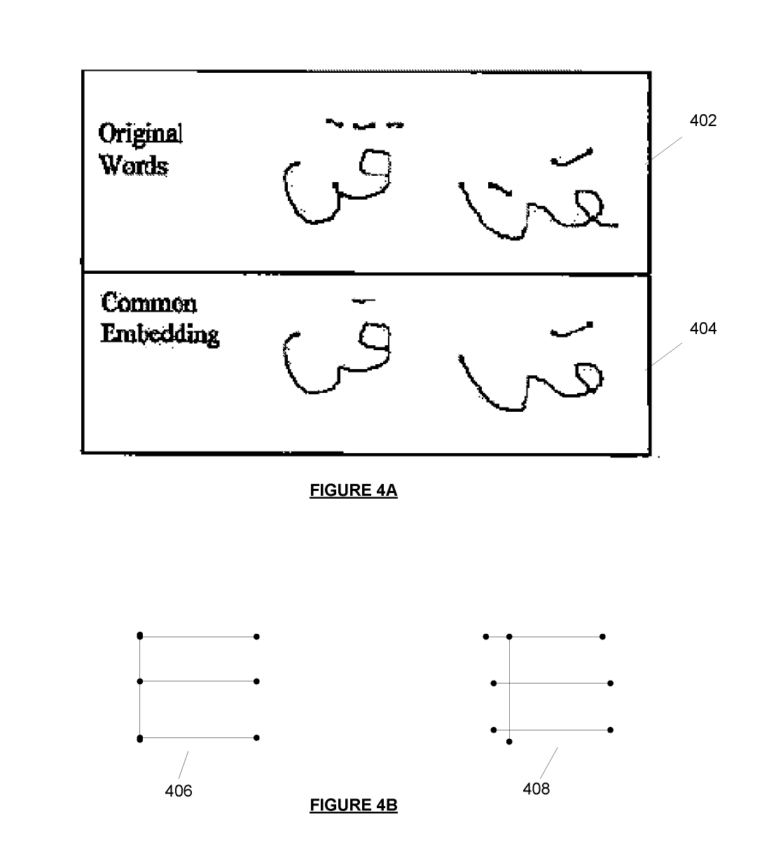

Identical characters, word segments, and/or words may result in graphs that have different topologies due to variations in the handwriting representations of the character or word segment. This is shown in FIG. 3A, where three different graph isomorphic classes are depicted for handwritten representations of the character “a”. That is, the classes labeled “2;192” 302, “4;112.0” 304, and “4;98.0.64” 306 all depict handwritten representations of the character “a”, each having a different topology. These “class numbers” are the numeric representation of the graph topologies generated by the current embodiment. Despite having different topologies, all three classes are handwritten depictions of the same character “a”. Moreover, different characters, word segments, and/or words may result in graphs that have identical topologies. Again, this is due to variations in the handwriting representations of the character string. This is shown in FIG. 3B, where representations of two separate topographic classes (i.e., “4;112.0” 308 and “4;98.0.64” 310) show that characters “a” and “e” may share the same identical topographic class.

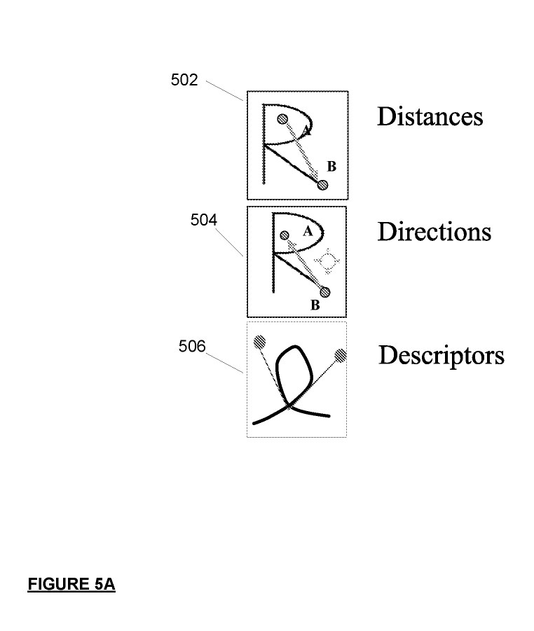

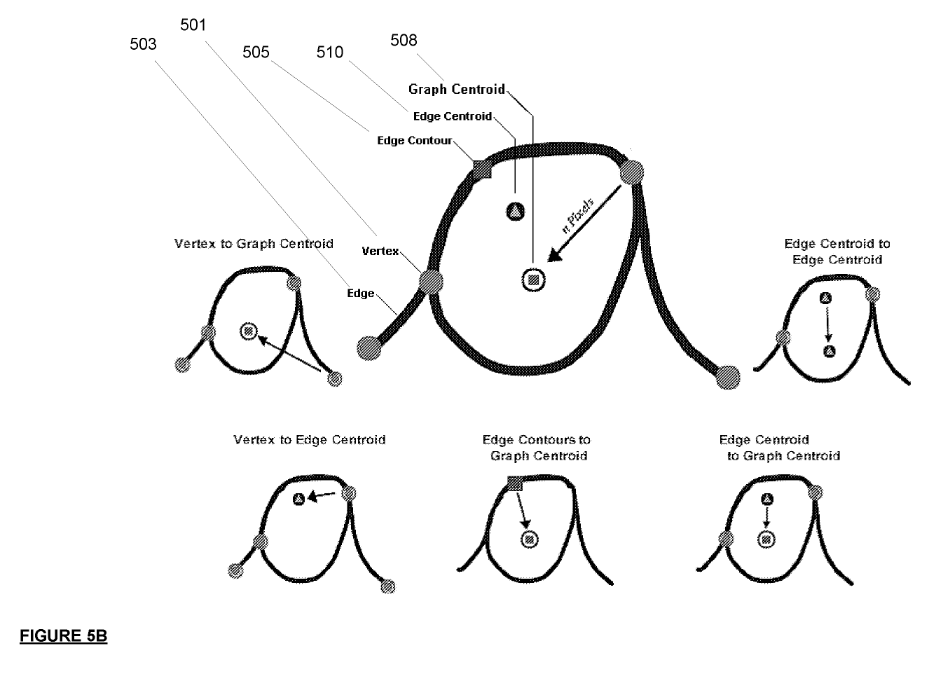

Handwritten representations of the same characters, word segments (i.e., character sequences) and words are usually quite similar graphically and distinguished only by a few differences such as extra or omitted strokes. Because of these differences, the graphs that they produce will be different within the strict definition of graph isomorphism. However, as depicted in FIG. 4A, there will often exist an embedded graph that transcends multiple handwriting samples and is isomorphic across samples. This embedded graph is referred to herein as the “common embedded form”. In FIG. 4A, the common embedded forms 404 of two handwritten representations of a first Arabic word segment 402 are depicted. As can be seen in FIG. 4A, the two handwritten forms of the first Arabic word segment 402 have several differences principally related to additional strokes along the top and bottom of the word segment 402. However, they do share significant common embedding as shown by the common embedded graphs 404 in the lower portion of the figure. FIG. 4B shows two examples of the character “E” where the left form 406 is completely embedded in the right form 408. It should be understood that the concept of common embedded forms is not unique to Arabic, or English. This concept applies to all written languages including those with “Latin-based” characters, such as English, Semitic languages such as Arabic and particularly applies to “pictoform-based” languages such as Kanji and Chinese.

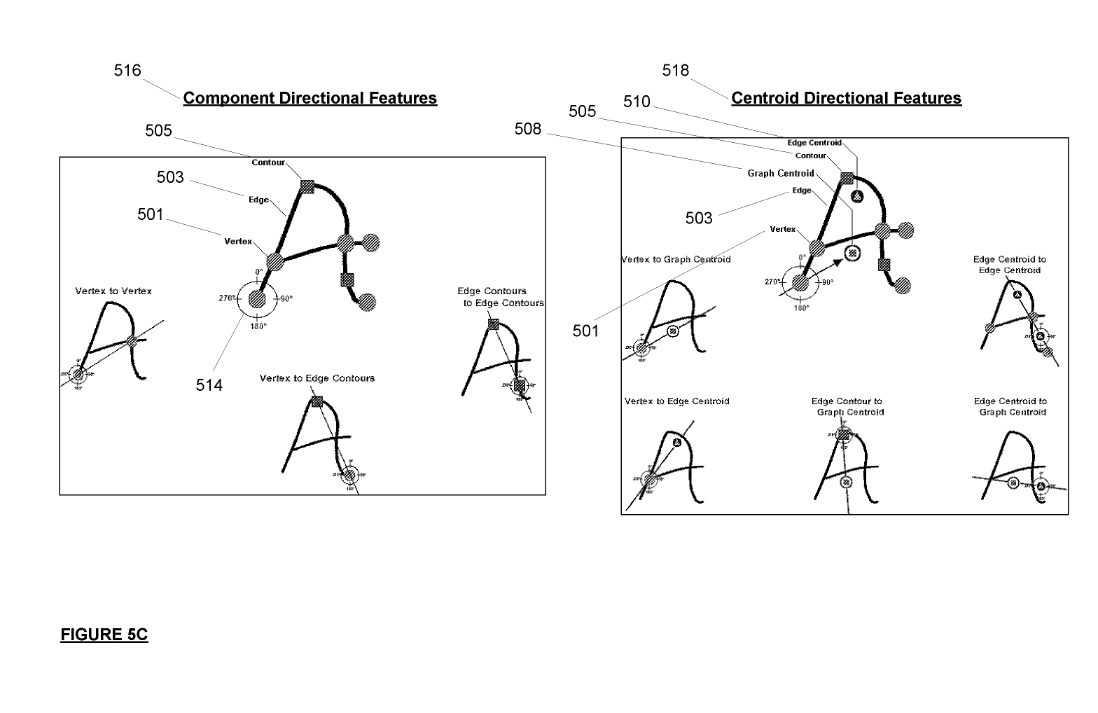

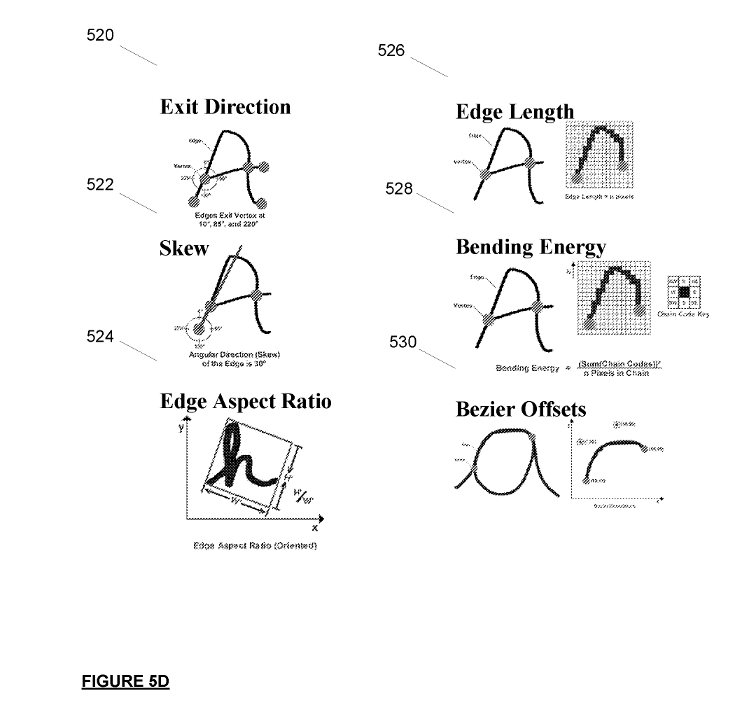

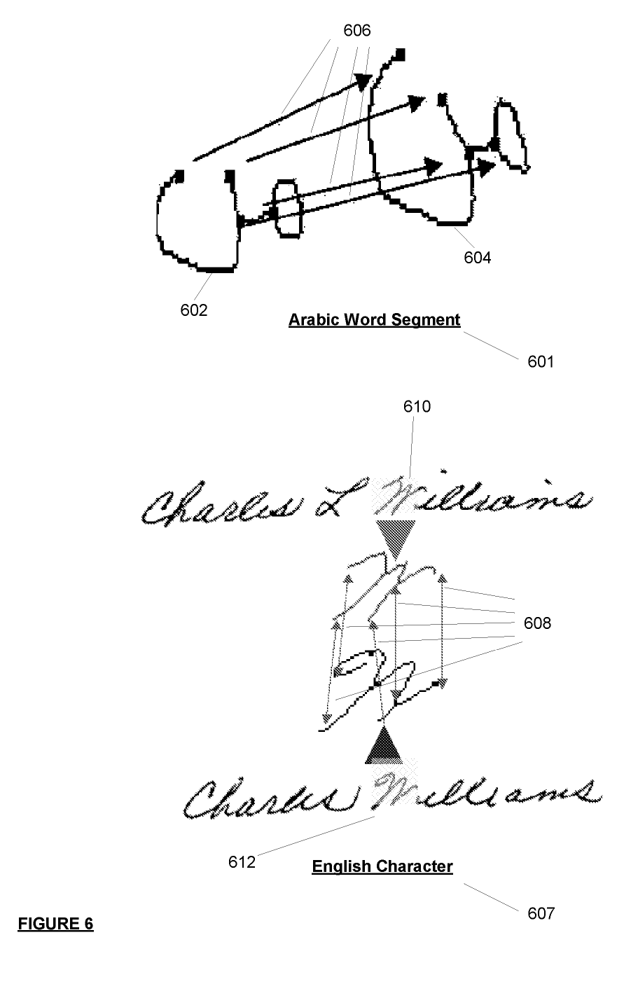

FIG. 5A is an illustration of the various types of measurements that can be obtained from a character, word segment, or word graph, in accordance with one embodiment. As depicted herein, the distances 502 among the various graph features may be measured. In one embodiment, the graph features measured are the nodal points 501 (i.e., vertices) of the graph. In another embodiment, the graph features measured are the linkages (i.e., edges) 503 of the graph. In still another embodiment, the graph features measured are a mixture of the nodal points 501 and linkages 503 of the graph. It should be understood that any type or form of graph features may be measured as long as the features may be reproducibly located on the graph. For example, as shown in FIG. 5B, the distances can be measured between other graph features such as the edge contours 505, graph centroid 508, and the edge centroid 510. In PR methodology, the action of determining graph isomorphism leading to the production of the isomorphic key yields a byproduct in the form of graph alignment. That is, once two graphs have been determined to be isomorphic, the same method yields a one-to-one mapping of the linkages (i.e., edges) and nodal points (i.e., vertices) between graphs. This mapping enables physical measurements to be directly compared.

Furthermore, the directions 504 among the various graph features can be measured. The direction 504 being quantified as the angles between the various graph components. As shown in FIG. 5C, the angle 514 may be measured in two separate classes of graph components: the component directional features 516 and the centroid directional features 518.

Examples of component directional features 516 include the graph nodal points (i.e., vertices), linkages 503 (i.e., edges), and edge contours 505. In one embodiment, the angle 514 is measured from one nodal point 501 to another nodal point 501. In another embodiment, the angle measured from one edge contour 505 to another edge contour 505. In still another embodiment, the angle measured is from one edge contour 505 to a nodal point 501 or vice versa. It should be appreciated, that the angles 514 between any type of component directional features 516 can be measured as long as the features can be reproducibly located on the graph.

Examples of centroid directional features 518 include the graph centroid 508 and the edge centroid 510. In one embodiment, the angle 514 is measured between some pairing of a nodal point 501 with either a graph centroid 508 or an edge centroid 510. In another embodiment, the angle 514 is measured between one graph centroid 508 and another graph centroid 508. In still another embodiment, the angle 514 is measured between one edge centroid 510 and another edge centroid 510. It should be understood, that the angles 514 between any type of centroid directional features 518 can be measured as long as the features can be reproducibly located on the graph.

Continuing with FIG. 5A, various other forms of descriptor features 506 on the graph may also be measured. As shown in FIG. 5D, these other forms of descriptor features 506 include the exit direction 520, the skew 522, the edge aspect ratio 524, the edge length 526, the bending energy 528, and the Bezier offsets 530. The exit direction 520 represents the direction an edge (i.e., linkage) exits a vertex (i.e., nodal point). The skew 522 is the angular direction of an edge. The edge aspect ratio 524 is the ratio of the height and width edge. The edge length 526 is the actual path length along an edge. The bending energy 528 is the amount of curvature in an edge. The Bezier offsets are the X and Y coordinates of the Bezier descriptors. Bezier descriptors are individual points that can be linked to the mathematical representation of a curve.

Together, the various types of measurements (e.g., distance 502, direction 504, and descriptor features 506) discussed above comprise the feature vectors for a graph extracted from a handwritten character string. The combination of the topology and feature vectors can be used to identify any handwritten character string. It is important to note that the graph feature vectors of a character string graph can consist of any combination of the graph features measurements just described.

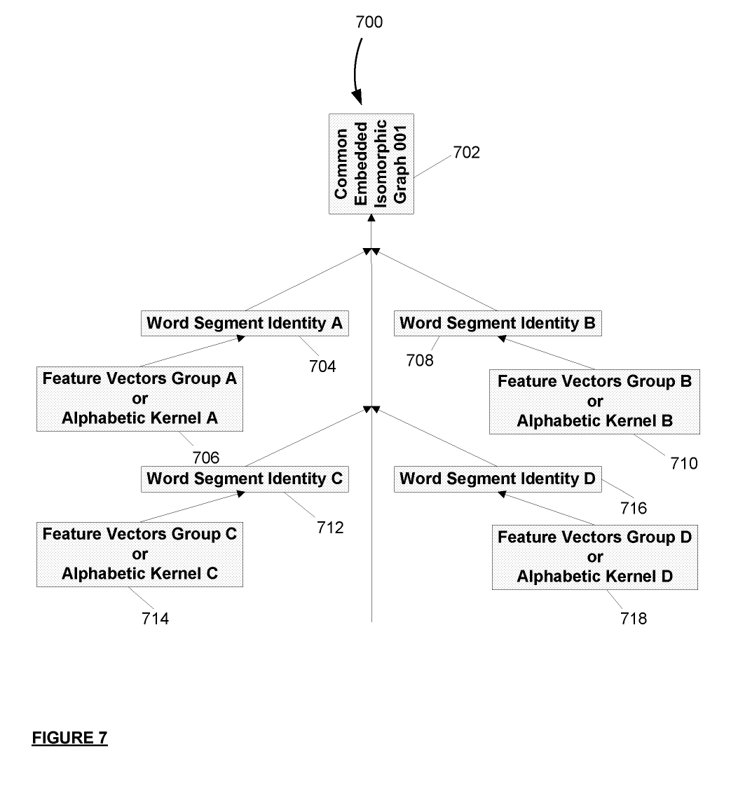

FIG. 6 is a depiction of how the isomorphic graphs from different handwriting samples can be aligned for feature vector comparison purposes, in accordance with one embodiment. As shown herein, an alignment is performed for two different handwriting samples of an Arabic word segment 601. A first isomorphic graph 602 generated from a first handwriting sample of an Arabic word segment is matched and aligned against a second isomorphic graph 604 generated from a second handwriting sample of the same Arabic word segment. A match means that the topologies of the two graphs are identical, which is the very definition of graph isomorphism. An identical approach to alignment is also shown for two different handwriting samples of an English character 607. As depicted, a first isometric graph 610 generated from a first handwriting sample of an English character “W” is matched and aligned against a second isometric graph 612 generated from a second handwriting sample of the same English character.

In one embodiment, alignment means that all nodal points (i.e., vertices) and linkages have achieved “point-to-point” alignment in corresponding pairs, indicated by the arrows 606 and 608 in the figure. In another embodiment, alignment means that only the nodal points have achieved “point-to-point” alignment in corresponding pairs. In still another embodiment, alignment means that only the linkages have achieved “point-to-point” alignment. After the nodal points and/or linkages are aligned, the graph feature vectors of the first (i.e., 602 and 610) and second (i.e., 604 and 612) isomorphic graphs can be compared in detail to equate or distinguish one graph from the other.

As shown in FIG. 6, the first (i.e., 602 and 610) and second (i.e., 604 and 612) isomorphic graphs were extracted from different handwritings samples of the same word or character from different writers; however, they share common isomorphic graph forms (i.e., matching) and when aligned their feature vectors are compared against each other to see if the characters or word segments they represent are equivalent. In one embodiment, the comparison results in a numerical rating that is indicative of how well the two graphs match one another. For example, a numerical value may be provided after the comparison that is directly proportional to how well the various feature measurements of the two graphs fit each other. In another embodiment, that comparison results in a probability conclusion. For example, the comparison may result in a percentage value (that varies from 0 to 100) that is related to the probability that the two graphs match based on how many of the various feature vector measurements equate between the two graphs match. In still another embodiment, the comparison results in a definitive conclusion of whether a match exists. For example, the comparison may result in a “yes” or “no” type of output from the comparison.

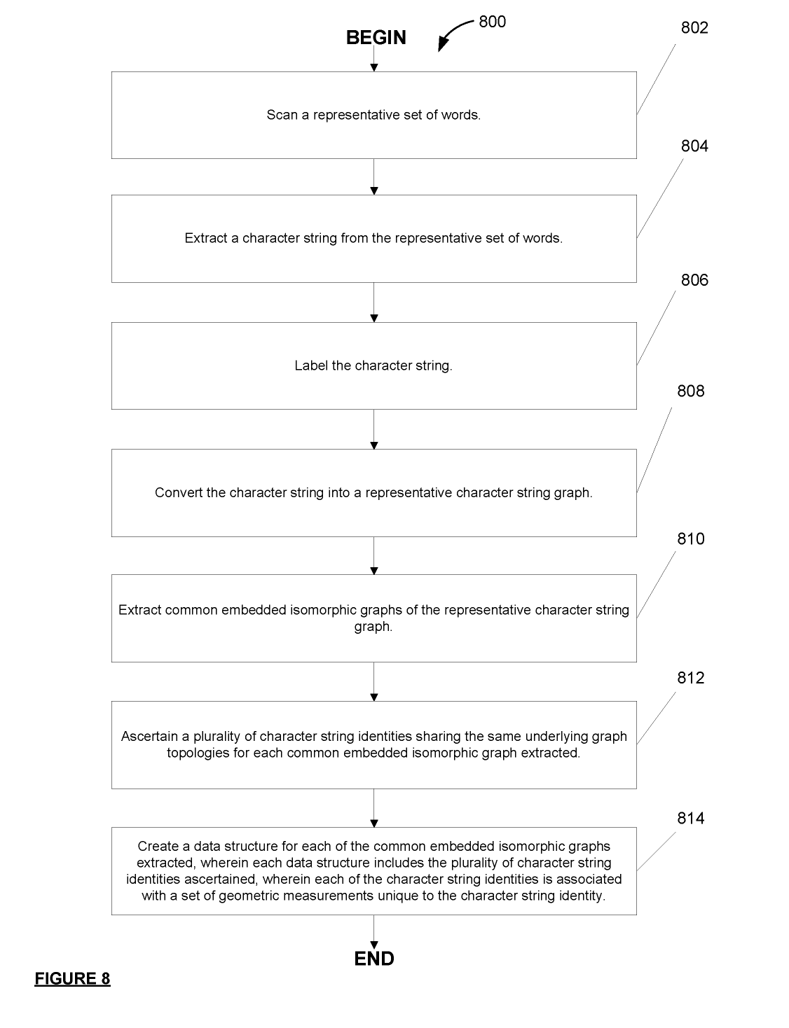

FIG. 7 is a tree diagram illustrating the process flow for how the feature vectors may be used to distinguish the graph from one particular character, word segment, or word from all the other characters, segments or words having the same isometric graph, in accordance with one embodiment. In this figure, a tree diagram 700 is shown of a common embedded isomorphic graph “001” 702 form that is common for various different word segments (i.e., Word Segment Identity A 704, Word Segment Identity B 708, Word Segment Identity C 712, and Word Segment Identity D 716) each associated with a unique grouping of feature vectors or an Alphabetic Kernel (i.e., Feature Vectors Group A or Alphabetic Kernel A 706, Feature Vectors Group B or Alphabetic Kernel B 710, Feature Vectors Group C or Alphabetic Kernel C 714, and Feature Vectors Group D or Alphabetic Kernel D 718). As discussed above, feature vectors are the multitude of measurements that are extracted from a graph that distinguishes a particular character string from other characters, character strings that share the same topology (i.e., the same isometric graph form). It should be appreciated, that FIG. 7 depicts the process flow for distinguishing between different word segments by way of example only. In separate embodiments, the same process may be repeated to distinguish between different individual characters and whole words.

Alphabetic Kernels are multi-dimensional expressions of the actual physical features used to differentiate among character strings. Graphs present the opportunity to capture numerous physical measurements. A relatively simple graph, such as a “T” shape can be measured in hundreds of distinctive ways. Many of these measurements are highly correlated and when taken in full force represents the mathematical bane often referenced as “the curse of dimensionality”. This “curse” results from having so much data that even items in the same class—such all written versions of the lowercase letter “a”—are differentiated from each other. This abundance of information is not always necessary for distinguishing among written forms. Rather, there are a few salient features that distinguish one written class from another—such as distinguishing a “b” from a “d” where the “curved” edge is located on the right side of the “b” and the left side of the “d”. This salient set of features is referenced as the Alphabetic Kernel.

Alphabetic Kernels can be “teased” from the full set of feature vectors using a variety of techniques. In one embodiment the kernels are generated using a Regression Tree Classifier to identify the set of variables that distinguishes all class representations sharing the same isomorphic structure. The Regression Tree Classification builds a decision tree where each “split” is based on the values of physical measures. When the tree structure is created, certain key measurements (i.e., features vectors) are used as the basis for the branching decisions. The tree structure leads to a set of “Terminal Nodes” each representing a particular character or word segment identity. A graph can be classified using a tree by evaluating the physical measurements (i.e., features vectors) that are related to each branching decision. These measures are derived directly from the full graph feature vector. The tree is built during a modeling activity using the Regression Tree Classifier. When an actual classification of a graph is performed, decisions are made and a path followed until a “Terminal Node” is reached. Assigned to the “Terminal Node” is the classification value that the tree will assign to the graph being evaluated. The set of measures used to support the decisions leading to this classification are the Alphabetic Kernel. Alphabetic Kernels are unique to each graph isomorphism and to the various individual classes that share this isomorphism. They serve to distinguish the numerous classes of character strings (such as PAWs) that share the same isomorphic graph. It should be appreciated, however, that the kernels can be generated using any classifier modeling format (e.g. discriminant analysis, neural networks, etc.) as long as the resulting kernel can be adequately processed by a conventional computing device during the matching of an unknown character string against the various different character string identities saved in a data structure.

Continuing with FIG. 7, an example of a “Terminal Node” on a tree structure is provided where Word Segment Identity A 704 is associated with Features Vectors Group A or Alphabetic Kernel A 706, which distinguishes Word Segment Identity A 704 from all the other word segments (i.e., Word Segment Identity B 708, Word Segment Identity C 712, and Word Segment Identity D 716) that share the same common embedded isomorphic graph “001” 702 form. To identify an unknown character string, the feature vector or Alphabetic Kernel of the unknown character string is evaluated using a decision tree structure derived from the features vector or Alphabetic Kernel that describes a known character string sharing the same common embedded isomorphic graph. In one embodiment, the tree diagram 700 is saved as a dynamic link library (DLL) file that can be accessed during a comparison of the graphs. It should be understood, however, that the tree diagram 700 and related decision structures may be saved in any data file format (i.e., Extensible Markup Language, etc.) as long as the file format can capture the essential distinguishing characteristics (e.g., topologies, feature vectors, Alphabetic Kernels, etc.) of a graph so that it can be compared later for matching purposes. In other words, the essential logic to distinguish one written form from another can be stored both as data as well as executable computer code. The principal criterion for selecting the actual format is a function of actual throughput requirements for performing recognition.

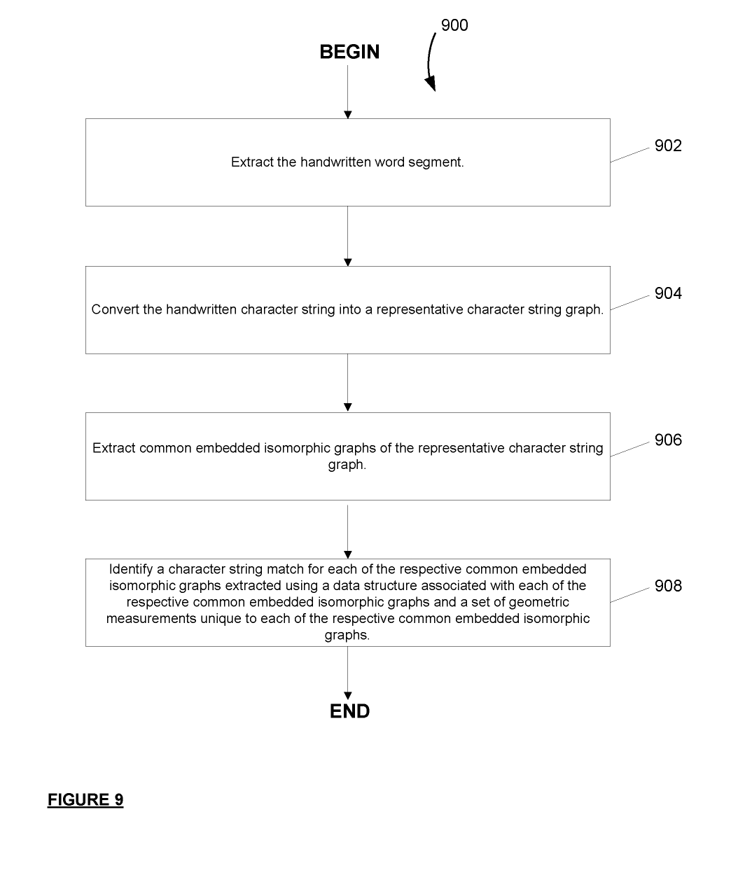

FIG. 8 is a flowchart of a method for creating a modeling structure for the various common embedded isomorphic graphs used in classifying handwritten words, word segments or characters, in accordance with one embodiment. Simply, as shown in FIG. 7, the modeling structure (i.e., tree diagram 700) maps out the feature vector characteristics of various word segment identities sharing the same embedded isomorphic graph form to support the classification of handwritten word segments. However, as discussed above, it should be understood that in other embodiments the same modeling structure depicted in FIG. 7 can be used to map out the feature vector characteristics of various individual characters or entire words sharing the same embedded isomorphic graph form. Method 800 begins with operation 802 where a representative set of handwritten words is scanned (i.e., extracted) into memory of a conventional computing device using a conventional imaging device. In one embodiment, the handwritten words are written in Arabic language script. In another embodiment, the handwritten words are written in English language script. It should be appreciated that the handwritten words may be written in any language as long as the words may be processed by a conventional computing device using algorithms based on Graph Theory into a graphic form that captures nodal point, linkage and vector feature information unique to the word.

The method 800 proceeds to operation 804 where a character string from the representative set of words is extracted. The character string may be comprised of any single character or continuous combination of characters within a word found in the representative set of words including the entire word itself. In one embodiment, the character grouping that comprises the character string is extracted based on the handwriting conventions that are characteristic for the language in which the word is written in. For example, handwritten Arabic words exhibit intrinsic segmentation (i.e., natural intra-word gaps) into character groups. This intrinsic segmentation occurs because Arabic handwriting conventions dictate that certain Arabic characters always connect while others never connect. In another embodiment, the character groupings may be extracted based on user defined rules that are particular to the particular language that the handwritten word is written in. It should be appreciated, however, that the character groupings may be extracted in accordance with any defined rule or characteristic of the handwritten word as long as the application of the rule or characteristic is reproducible from one iteration to the next.

The extraction of the character string in operation 804 can either be manual or automatic. In the case of manual extraction, a human operator uses a specially designed computer program to encapsulate the character strings graphically by drawing a polygon around these objects in a scanned image taken from an original document. In the case of automatic extraction, a computer program processes the image using prescribed logic (e.g., handwriting convention, user defined rules, etc.) to detect forms that should be extracted and labeled. This method presumes the writers who provide the handwriting samples write specified words, phrases and sentences in accordance with an established “script”. Since a script is used to capture writing for automated extraction, this script is used to provide the identity of each extracted object. In the manual method, this identity is provided by human operators.

The method 800 moves on to operation 806 where the character string is labeled to clearly delineate the original identity of the character string. In one embodiment, the character string is labeled manually by an operator who types in the identity of the character string as each item is encapsulated during the manual extraction step described above. In another embodiment, the character string is labeled automatically using a script designed to provide the identity of each object (i.e., character string) extracted using the script.

The method 800 continues on to operation 808 where the character string is converted into a representative character string graph. Essentially, a character string graph coverts all the information extracted from the character string into a concise mathematical format that is highly computable. In one embodiment, a character string graph is comprised of the multiple nodal points and linkages within the character string. In another embodiment, the character string graph is comprised of either the nodal points or the linkages within the character string. It should be understood, however, that the character string graph may be comprised of any graphical information regarding the visible features of the character string as long as the information representing the unique aspects of the character string is reproducible.

Method 800 moves on to operation 810 where all the common embedded isomorphic forms of the representative character string graph are extracted. The common embedded isomorphic forms are those embedded graphs that capture the essential defining characteristics of the character string being processed. In one embodiment, during the identification of the common embedded isomorphic forms, a threshold setting may be used. For example, the threshold may be set to extract only those embedded graphs that occupy more than 75 percent of the graph's structure of the original character string from which they were extracted. It should be appreciated, however, that this threshold setting is presented by way of example only, in practice the threshold setting may be set to any value so long as the resulting common embedded graphs extracted retain the essential defining characteristics of the original character string graph.

In one embodiment, the common embedded isomorphic graphs of a character string are extracted using an “isomorphic database”. That is, a database where all the common embedded isomorphic forms of a graph having a particular topology may be stored. For example, during a lookup on the isomorphic database, a character string is first converted into a graph to generate an isomorphic key based on the nodal points and linkages in the graph. The isomorphic key is then matched to the isomorphic database to extract all the common embedded isomorphic graphs for the particular character string that does not fall below a threshold value. In another embodiment, an algorithm is applied to the character string to arrive at all the common embedded isomorphic forms. This is accomplished by the algorithm “toggling on” and “toggling off” certain features (e.g., edges, nodal points, etc.) of the character string graph in accordance with a threshold setting. This technique will produce 2ⁿ embedded graphs where “n” is the total number of graph features (nodes or strokes) in the graph. A threshold can be implemented using the physical dimensions of each edge and establishing a ratio of the aggregate lengths represented by the total number of edges toggled “off” or “zero” to the aggregate length of all edges in the entire graph. Thus, a threshold of 75 percent would include all embedded graphs that comprised “at least” 75 percent of the aggregate edge length entire graph.

The method continues on to operation 812 where a plurality of character string identities sharing the same underlying graph topologies of each of the common embedded isomorphic graphs extracted are ascertained. That is, various different character strings are identified for each of the common embedded isomorphic graphs extracted, each of the character strings having the same underlying graph topologies.

The method next proceeds to operation 814 where a data structure is created for each of the common embedded isomorphic graphs extracted. Each data structure including the plurality of different character strings that were ascertained for the character string. Each of the plurality of different character string identities are associated with a set of feature vectors (i.e., feature vectors groups or Alphabetic Kernels) unique to the character string identities. An example of the associations created by the data structure is illustrated in FIG. 7, which depicts a tree diagram 700 of various different character string identities (e.g., Word Segment Identity A 704, Word Segment Identity B 708, Word Segment Identity C 712, and Word Segment Identity D 716) each sharing the same underlying graph topology (i.e., common embedded isomorphic graph “001” 702) and associated with a grouping of feature vectors (i.e., Feature Vectors Group A or Alphabetic Kernel A 706, Feature Vectors Group B or Alphabetic Kernel B 710, Feature Vectors Group C or Alphabetic Kernel C 714, and Feature Vectors Group D or Alphabetic Kernel D 718) unique to each particular character string.

In one embodiment, the data structure encompassing the Alphabetic Kernels is derived using a regression tree classifier format. In another embodiment, the data structure is derived using a method based on discriminant analysis. In a third embodiment a neural network format is used. In all cases, the methods used to derive the data structure are configured to glean from the entire universe of features (the complete listing of feature vectors) a subset of salient features that effectively distinguish one class from another (i.e., the Alphabetic Kernel). This data structure derived during modeling provides the basis for classification of various classes sharing the same isomorphic structure by focusing on those features exhibiting the greatest power of discrimination among different classes. It should be appreciated, however, that the data structure can be derived and used for classification employing any predictive modeling format as long as the resulting structure can be adequately processed by a conventional computing device during the matching of an unknown character string against the various different character string identities saved in the structure.

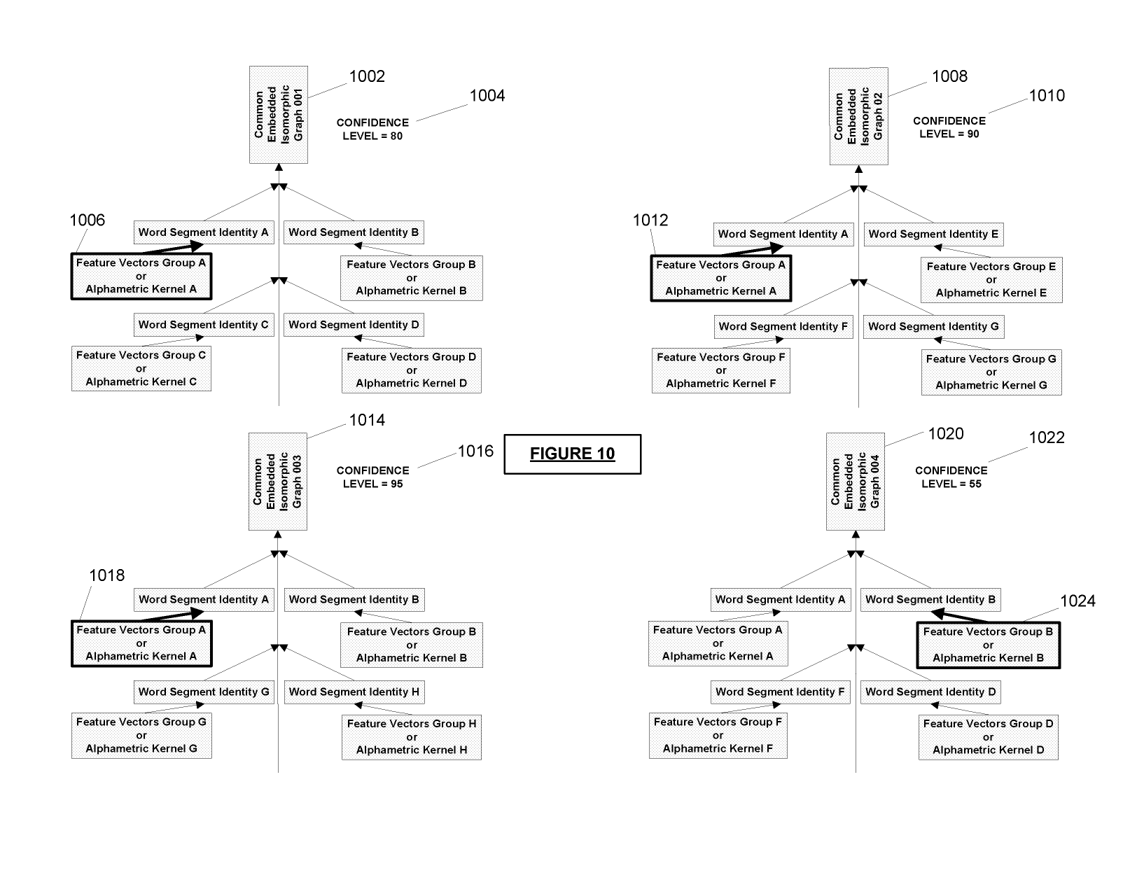

FIG. 9 is a flowchart depicting a method for identifying handwritten character strings, in accordance with one embodiment. As depicted in this flowchart, method 900 begins with operation 902 where a handwritten character string is extracted from a handwritten word. The character string may be comprised of any single character or continuous combination of characters within a word found in the representative set of words including the entire word itself. In one embodiment, the handwritten character string is written in Arabic language script. In another embodiment, the handwritten character string is written in English language script. It should be appreciated that the handwritten character string may be written in any language as long as the character string may be processed by a conventional computing device into a graphic form that captures nodal point, linkage and vector feature information unique to the character string.

The character string may be comprised of any single character or continuous combination of characters within the handwritten word including the entire word. In one embodiment, the character grouping that comprises the character string is extracted based on the handwriting conventions that are characteristic for the language in which the word is written in. For example, it is well known in the art that handwritten Arabic words exhibit intrinsic segmentation (i.e., natural intra-word gaps) into character groups. This intrinsic segmentation occurs because Arabic handwriting conventions dictate that certain Arabic characters always connect while others never connect. In another embodiment, the character groupings may be extracted or parsed based on user defined rules that are particular to the particular language that the handwritten word is written in. For example, prominent word features such as “ascenders” or “descenders” could be used as the basis for extracting character strings. Ascenders are characters that extend above the base body of a word. Descenders extend below the base body of a word. Other features could include “diacritical markings” such as dot over the letter “i”. It should be appreciated, however, that the character groupings may be extracted in accordance with any defined rule or characteristic of the handwritten word as long as the application of the rule or characteristic is reproducible from one iteration to the next for particular written forms.

As was true in the case of modeling, the extraction of the character string in operation 902 can either be manual or automatic. However, in the majority of applications, the extraction will be automated. In the case of manual extraction, a human operator uses a specially designed computer program to encapsulate the character strings graphically by drawing a polygon around these objects in a scanned image from an original document. In the case of automatic extraction, a computer program processes the image using prescribed logic (e.g., handwriting convention, user defined rules, etc.) to detect forms that should be extracted and labeled. These rules derive from language characteristics such as the direction in which a language is written and read. For instance, English is written and read from left to right and Arabic is written and read from right to left. Other languages, such Chinese as may move from top to bottom of a page. These language conventions are but one set of requirements that drive extraction of written words. Other requirements include but are not limited to “white space” between written forms and “prominent features” within these forms.

Method 900 moves on to operation 904 where the handwritten character string is converted into a representative character string graph. As described above, a character string graph coverts all the information extracted from the character string into a concise mathematical format that is highly computable. In one embodiment, a character string graph is comprised of the multiple nodal points and linkages within the character string. In another embodiment, the character string graph is comprised of either the nodal points or the linkages within the character string. It should be understood, however, that the character string graph may be comprised of any graphical information regarding the visible features of the character string as long as the information can be used to uniquely represent the unique aspects of the character string are reproducible.

Method 900 proceeds to operation 906 where all the common embedded isomorphic forms of the representative character string graph are extracted. As discussed previously, the common embedded isomorphic forms are those embedded graphs that capture the essential defining characteristics of the character string being processed. In one embodiment, during the identification of the common embedded isomorphic forms, a threshold setting may be used. For example, the threshold may be set to extract only those embedded graphs that occupy more than 75 percent of the graphs structure of the original character string form which they were extracted. It should be appreciated, however, that this threshold setting is presented by way of example only in practice the threshold setting may be set to any value so long as the resulting common embedded graphs extracted retain the essential defining characteristics of the original character string graph.

In one embodiment, the common embedded isomorphic graphs of a character string are extracted using an isomorphic database. That is, a database where all the common embedded isomorphic forms of a graph having a particular topology may be stored. For example, during a lookup on the isomorphic database, a character string is first converted into a graph to generate an isomorphic key based on the nodal points and linkages in the graph. The isomorphic key is then matched to the isomorphic database to extract all the common embedded isomorphic graphs for the particular character string that doesn't fall below a threshold value. In another embodiment, an algorithm is applied to the character string to arrive at all the common embedded isomorphic forms. This is accomplished by the algorithm “toggling on” and “toggling off” certain features (e.g., edges, nodal points, etc.) of the character string graph in accordance with a threshold setting. This technique will produce 2ⁿ embedded graphs where “n” is the total number of graph features (nodes or strokes) in the graph. A threshold can be implemented using the physical dimensions of each edge and establishing a ratio of the aggregate lengths represented by the total number of edges toggled “off” or “zero” to the aggregate length of all edges in the entire graph. Thus, a threshold of 75 percent would include all embedded graphs that comprised “at least” 75 percent of the entire graph. For example, if the threshold setting is at 75 percent, the algorithm will toggle the various features (e.g., nodal points, edges, etc.) on the character string graph and extract only those embedded graphs that occupy more than 75 percent of the aggregate edge length in the graph structure of the original character string form.

The method 900 continues on to operation 908 where a character string match is classified. Classification is the process of establishing an unknown graph's identity from each of its respective identification of common embedded isomorphic graphs. These embedded graphs are extracted using a data structure associated with each of the respective common embedded isomorphic graphs and feature vectors of the handwritten character string. As previously discussed in relation to FIG. 8 and depicted in FIG. 7, data structures (i.e., modeling structures) map out various character string identities sharing the same common embedded isomorphic graph forms to aid in the classification of handwritten character strings. The data structures associate each of the various character string identities with a multitude of measurements unique to each of the character string segment identities within any particular isomorphism. In the modeling stage, a salient set of features (i.e., Alphabetic Kernel or Feature Vectors Group) was identified for each character string identity. In classification, this set of features is used to support the decisions determining the identity of an unknown graph. In one embodiment, the multitude of measurements are presented in the form of a set of features vectors. In another embodiment, the multitude of measurements are presented in the form of an Alphabetic Kernel, which is just a multi-dimensional subset taken from the set of feature vectors.

For example, given an unknown handwriting character string A, 10 common embedded isomorphic graphs can be extracted from this form by toggling features and using a prescribed threshold value. The full graph and its 10 embeddings each present a multitude of measurements unique to each graph's topology (isomorphism). The unknown graph and its 10 embeddings can used to produce 11 isomorphic keys (the one unknown graph plus 10 embedded graphs yields 11 graphs). Each of these 11 keys will produce a feature vector consistent with each individual graph's isomorphism. These 11 isomorphisms and feature vectors can be then matched against the data structures for each of the 11 common embedded isomorphic graphs extracted during modeling. Using the features vectors or Alphabetic Kernels associated with the various character string identities within each data structure, a determination is made as to which of the character string identities best matches the 11 graphs extracted from handwritten character string A. It should be appreciated that the matching of the 11 graphs extracted from character string A to the data structures for 11 graphs matching character string A's full graph and each of its 10 common embedded isomorphic graphs may produce different results: (1) the same character string identity being identified for all 11 graphs classified, (2) different character strings identified for all 11 graphs or (3) some result in between. Again, the actual classification can be performed using decision trees derived through regression trees, discriminant analysis, neural networks or other methods that can be applied to classification problems.

The classification results from an unknown graph and its embeddings can be “voted” in a variety of ways to determine an overall classification value. In one embodiment, the results can be tabulated and the class matched to the most embeddings would be considered the best match. In another embodiment, a matrix method of scoring could be employed and the results could either be tabulated or distilled into a 2 by 2 contingency table to which an “odds ratio” methodology could be applied.

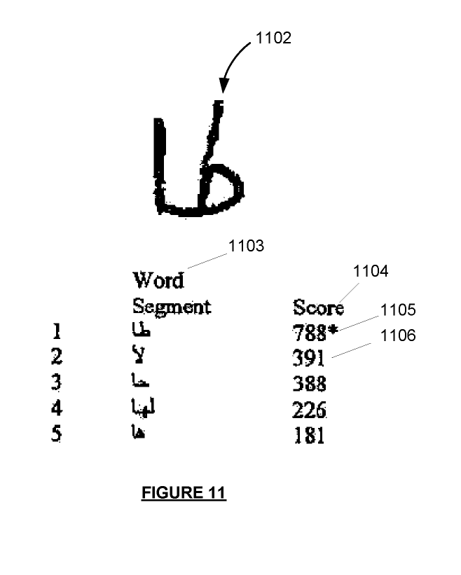

FIG. 10 is a depiction of the results of a classification of an unknown handwritten character string utilizing the data structures of the common embedded isomorphic graphs extracted for a handwritten character string, in accordance with one embodiment. As depicted herein, the data structures for the four different common embedded isomorphic graphs (e.g., Common Embedded Isomorphic Segment “001” 1002, Common Embedded Isomorphic Segment “002” 1008, Common Embedded Isomorphic Segment “003” 1014, and Common Embedded Isomorphic Segment “004” 1020) extracted from an unknown word segment (i.e., character string) is presented. It should be understood that the number of common embedded isomorphic graphs identified for a character string varies generally in accordance with the overall complexity of the character string structure and that four isomorphic graphs are presented herein by example only. Also, the full graph is also considered an embedded form where the embedding threshold is 100 percent.

During a character string classification operation, a multitude of measurements extracted (i.e., feature vectors, Alphabetic Kernel) from the unknown character string's embeddings are matched against each of the data structures for the extracted common embedded isomorphic graphs using a decision tree or comparable classification method. It should be noted that character string identities may be common across multiple data structures. That is, during matching of the measurements from the unknown character string against the data structures of the common embedded isomorphic graphs extracted, the same character string identity may result. For example, as shown herein, the data structures for the common embedded isomorphic graphs “001” 1002, “002” 1008, and “003” 1018 each matched the unknown word segment to word segment identity A (1006, 1012, and 1018). In addition to identifying a word segment identity, the matching operation results in a quantitative expression of the confidence level (see features 1004, 1010, 1016, and 1022) that the matched word segment identity is correct. In one embodiment, the quantitative expression is an expression of probability that the character string identity matched is correct. In another embodiment, the quantitative expression is a simple character string (numerical or otherwise) that is indicative of the level of confidence that the character string matched is correct.

FIG. 11 is an illustration of how the results from a classification of an unidentified handwritten character string using a data structure may be presented, in accordance with one embodiment. As shown herein, the results table for an unknown character string 1102 contains two separate columns (i.e., “Word Segment” column 1103 and “Score” column 1104) summarizing the results from matching the unknown character string 1102 to the various common embedded isomorphic graphs extracted from the unknown handwritten character string 1102. The table presents the character string identities with the highest classification scores in descending order (character string identity with the highest classification score presented first). In one embodiment, the values in the “Scores” column 1104 are tabulated as the sum of the confidence level scores for each character string identity identified during the classification of the unknown character string 1102 against all the individual common embedded isomorphic graphs extracted for the character string 1102. For example, as shown in FIG. 10, character string identity A (1006, 1012, 1018) results from the classification of the unknown character string against the common embedded isomorphic graphs “001” 1002, “002” 1008, and “003” 1014. The confidence levels (1004, 1010, 1016) for all three embedded isomorphic graphs would therefore be summed to come up with the total classification score for character string identity A (1006, 1012, 1018). The confidence level is established as the culmination of individual scores for embedded graphs.

Continuing with FIG. 11, an asterisk 1105 is affixed next to the score associated with the character string identity that is the correct identification of the character string 11 02. However, in practice, the correct character string identity would be unknown. Ideally, the character string identity with the highest classification score would always be the correct identification of the character string, however, that is not always the case.

The embodiments, described herein, can be practiced with other computer system configurations including hand-held devices, microprocessor systems, microprocessor-based or programmable consumer electronics, minicomputers, mainframe computers and the like. The embodiments can also be practiced in distributing computing environments where tasks are performed by remote processing devices that are linked through a network.

It should also be understood that the embodiments described herein can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations that form part of the embodiments described herein are useful machine operations. The invention also relates to a device or an apparatus for performing these operations. The systems and methods described herein can be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The systems and methods described herein can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Certain embodiments can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although a few embodiments of the present invention have been described in detail herein, it should be understood, by those of ordinary skill, that the present invention may be embodied in many other specific forms without departing from the spirit or scope of the invention. Therefore, the present examples and embodiments are to be considered as illustrative and not restrictive, and the invention is not to be limited to the details provided therein, but may be modified and practiced within the scope of the appended claims.

1. A method for creating a modeling structure for classifying Arabic character strings, comprising:
scanning a representative set of Arabic words;
extracting a character string from the representative set of Arabic words;
labeling the character string;
converting the character string into a representative character string graph;
extracting common embedded isomorphic graphs of the representative character string graph;
ascertaining a plurality of character string identities sharing the same underlying graph topologies for each common embedded isomorphic graph extracted; and
creating a data structure for each of the common embedded isomorphic graphs extracted, wherein each data structure includes the plurality of character string identities ascertained, wherein each of the character string identities is associated with a set of geometric measurements unique to the character string identity.

2. The method for creating a modeling structure for classifying Arabic character strings, as recited in claim 1, further including:
identifying nodal points and linkages on the representative character string graph; and
ascertaining an isomorphic database key for the representative character string graph based on the identified nodal points and linkages.

3. The method for creating a modeling structure for classifying Arabic character strings, as recited in claim 2, further including:
utilizing the isomorphic database key to extract the common embedded isomorphic graphs of the representative character string graph from an isomorphic database.

4. The method for creating a modeling structure for classifying Arabic character strings, as recited in claim 1, wherein the set of geometric measurements is in the form of an Alphabetic Kernel.

5. The method for creating a modeling structure for classifying Arabic character strings, as recited in claim 1, wherein the set of geometric measurements is in the form of features vectors.

6. The method for creating a modeling structure for classifying Arabic character strings, as recited in claim 1, further including:
utilizing an algorithm to extract the common embedded isomorphic graphs from the representative character string graph.

7. The method for creating a modeling structure for classifying Arabic character strings, as recited in claim 1, wherein the data structure is based on a regression tree classifier model.

8. The method for creating a modeling structure for classifying Arabic character strings, as recited in claim 1, wherein the data structure is based on a neural network classifier model.

9. The method for creating a modeling structure for classifying Arabic character strings, as recited in claim 1, wherein the data structure is based on a discriminant analysis model.

10. The method for creating a modeling structure for classifying Arabic character strings, as recited in claim 2, wherein the nodal points represent vertices identified on the representative character string graph.

11. The method for creating a modeling structure for classifying Arabic character strings, as recited in claim 1 wherein the character string is comprised of a single Semitic alphabetic character.

12. The method for creating a modeling structure for classifying Arabic character strings, as recited in claim 1 wherein the character string is comprised of an Arabic word segment.

13. The method for creating a modeling structure for classifying Arabic character strings, as recited in claim 1 wherein the character string is comprised of an Arabic word.

14. A method for recognizing handwritten Arabic character string, comprising:
extracting the handwritten Arabic character string;
converting the handwritten Arabic character string into a representative character string graph;
extracting common embedded isomorphic graphs of the representative character string graph; and
identifying a character string match from each of the respective common embedded isomorphic graphs extracted using a data structure associated with each of the respective common embedded isomorphic graphs and a set of geometric measurements unique to the handwritten Arabic character string.

15. The method for recognizing handwritten Arabic character string, as recited in claim 14, wherein the character string is comprised of a single Semitic alphabetic character.

16. The method for recognizing handwritten Arabic character string, as recited in claim 14, wherein the character string is comprised of an Arabic word segment.

17. The method for recognizing handwritten Arabic character string, as recited in claim 14, wherein the character string is comprised of an Arabic word.

18. The method for recognizing handwritten Arabic character strings, as recited in claim 14, further including:
identifying nodal points and linkages on the representative character string graph; and
ascertaining an isomorphic database key for the representative character string graph based on the identified nodal points and linkages.

19. The method for recognizing handwritten Arabic character strings, as recited in claim 18, further including:
utilizing the isomorphic database key to extract the common embedded isomorphic graphs of the representative character string graph from an isomorphic database.

20. The method for recognizing handwritten Arabic character strings, as recited in claim 14, further including:
utilizing an algorithm to extract the common embedded isomorphic graphs of the representative character string graph.

21. The method for recognizing handwritten Arabic character strings, as recited in claim 14, wherein the set of geometric measurements is in the form of an Alphabetic Kernel.

22. The method for recognizing handwritten Arabic character strings, as recited in claim 14, wherein the data structure is based on a regression tree classifier model.

23. The method for recognizing handwritten Arabic character strings, as recited in claim 14, wherein the data structure is based on a neural network classifier model.

24. The method for recognizing handwritten Arabic character strings, as recited in claim 14, wherein the set of geometric measurements is in the form of feature vectors.

25. A computing device for operating an Arabic language recognition process for handwritten Arabic words, the process comprising:
extracting the handwritten Arabic character string;
converting the handwritten Arabic character string into a representative character string graph;
extracting common embedded isomorphic graphs of the representative character string graph; and
identifying a character string match from each of the respective common embedded isomorphic graphs extracted using a data structure associated with each of the respective common embedded isomorphic graphs and a set of geometric measurements unique to the handwritten Arabic character string.

26. The computing device for operating an Arabic language recognition process for handwritten Arabic character strings, as recited in claim 25, wherein the character string is comprised of a single Semitic alphabetic character.

27. The computing device for operating an Arabic language recognition process for handwritten Arabic character strings, as recited in claim 25, wherein the character string is comprised of an Arabic word segment.

28. The computing device for operating an Arabic language recognition process for handwritten Arabic character strings, as recited in claim 25, wherein the character string is comprised of an Arabic word.

29. The computing device for operating an Arabic language recognition process for handwritten Arabic character strings, as recited in claim 18, further including:
identifying nodal points and linkages on the representative character string graph; and
ascertaining an isomorphic database key for the representative character string graph based on the identified nodal points and linkages.

30. The computing device for operating an Arabic language recognition process for handwritten Arabic character strings, as recited in claim 29, further including:
utilizing the isomorphic database key to extract the common embedded isomorphic graphs of the representative character string graph from an isomorphic database.

31. The computing device for operating an Arabic language recognition process for handwritten Arabic character strings, as recited in claim 25, further including:
utilizing an algorithm to extract the common embedded isomorphic graphs of the representative character string graph.

32. The computing device for operating an Arabic language recognition process for handwritten Arabic character strings, as recited in claim 25, wherein the set of geometric measurements is in the form of an Alphabetic Kernel.

33. The computing device for operating an Arabic language recognition process for handwritten Arabic character strings, as recited in claim 25, wherein the set of geometric measurements is in the form of feature vectors.

34. The computing device for operating an Arabic language recognition process for handwritten Arabic character strings, as recited in claim 25, wherein the data structure is based on a regression tree classifier model.

35. The computing device for operating an Arabic language recognition process for handwritten Arabic character strings, as recited in claim 25, wherein the data structure is based on a neural network classifier model.

36. The computing device for operating an Arabic language recognition process for handwritten Arabic character strings, as recited in claim 29, wherein the nodal points represent vertices identified on the representative character string graph.

37. A method for recognizing handwritten character strings, comprising:
extracting the handwritten character string;
converting the handwritten character string into a representative character string graph;
extracting common embedded isomorphic graphs of the representative character string graph; and
identifying a character string match from each of the respective common embedded isomorphic graphs extracted using a data structure associated with each of the respective common embedded isomorphic graphs and a set of geometric measurements unique to the handwritten character string.

38. The method for recognizing handwritten character strings, as recited in claim 37, wherein the character string is comprised of a single alphabetic character.

39. The method for recognizing handwritten character strings, as recited in claim 37, wherein the character string is comprised of a word segment.

40. The method for recognizing handwritten character strings, as recited in claim 37, wherein the character string is comprised of an entire word.

41. The method for recognizing handwritten character strings, as recited in claim 37, further including:
identifying nodal points and linkages on the representative character string graph; and
ascertaining an isomorphic database key for the representative character string graph based on the identified nodal points and linkages.

42. The method for recognizing handwritten character strings, as recited in claim 41, further including:
utilizing the isomorphic database key to extract the common embedded isomorphic graphs of the representative character string graph from an isomorphic database.

43. The method for recognizing handwritten character strings, as recited in claim 37, further including:
utilizing an algorithm to extract the common embedded isomorphic graphs of the representative character string graph.

44. The method for recognizing handwritten character strings, as recited in claim 37, wherein the set of geometric measurements is in the form of an Alphabetic Kernel.

45. The method for recognizing handwritten character strings, as recited in claim 37, wherein the set of geometric measurements is in the form of feature vectors.

46. A method for creating a modeling structure for classifying character strings, comprising:
scanning a representative set of words;
extracting a character string from the representative set of words;
labeling the character string;
converting the character string into a representative character string graph;
extracting common embedded isomorphic graphs of the representative character string graph;
ascertaining a plurality of character string identities sharing the same underlying graph topologies for each common embedded isomorphic graph extracted; and
creating a data structure for each of the common embedded isomorphic graphs extracted, wherein each data structure includes the plurality of character string identities ascertained, wherein each of the character string identities is associated with a set of geometric measurements unique to the character string identity.

47. The method for creating a modeling structure for classifying Arabic character strings, as recited in claim 46, wherein the data structure is based on a neural network classifier model.

48. The method for creating a modeling structure for classifying Arabic character strings, as recited in claim 46, wherein the data structure is based on a discriminant analysis model.

49. The method for creating a modeling structure for classifying Arabic character strings, as recited in claim 46, wherein the character string is comprised of a single Semitic alphabetic character.

50. The method for creating a modeling structure for classifying Arabic character strings, as recited in claim 46, wherein the character string is comprised of an Arabic word segment.

51. The method for creating a modeling structure for classifying Arabic character strings, as recited in claim 46, wherein the character string is comprised of an Arabic word.
